(19) United States
(12) Patent Application Publication
(10) Pub. No.: US 2016/0010776 A1
(43) Pub. Date: Jan. 14, 2016

(54) BATHTUB SPOUT ADAPTER FOR HOSE OR SPRAYER COUPLING

(71) Applicant: Steve Medina, Austin, TX (US)

(72) Inventor: Steve Medina, Austin, TX (US)

(21) Appl. No.: 14/329,091

(22) Filed: Jul. 11, 2014

(51) Int. Cl. F16L 37/127; F16L 15/00; F16L 37/00; F16L 37/28; F16L 55/07

(52) U.S. Cl. CPC F16L 37/127; F16L 37/28; F16L 55/07; F16L 37/006; F16L 15/00

(57) ABSTRACT

The present disclosure provides a plumbing adapter for coupling a hose and a spout. The plumbing adapter is provided as a plumbing assembly. The plumbing adapter includes a first portion having a hose pipe, a second portion having a support assembly and a third portion having a lock assembly. The hose pipe connects to a tap spout of a water dispensing system. The support assembly includes two parallel arms to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system.

### CROSS REFERENCE TO RELATED APPLICATIONS

This application claims the priority benefit of U.S. Provisional application Ser. No. 14/329,091 on Jul. 11, 2014, which is incorporated herein by reference in its entirety.

### TECHNICAL FIELD

The present invention relates to the field of coupling a hose to a spout and, in-particular, relates to the field of providing a device or an adapter to enable coupling of the hose to the spout.

### BACKGROUND

[In the present era, various types of fluid supply accessories, usable with taps/faucets/spigots, are available. Examples of the fluid supply accessories include but may not be limited to spouts, hoses, diverters and adapters. The fluid supply accessories are used with the taps/faucets/spigots of domestic bath taps, showers and the like. For example, a hose is connected to a spout of the tap/faucet/spigot to enable working of showers, domestic bath taps and the like. The tap/faucet/spigot is a valve assembly for controlling release of fluids. The fluid supply accessories are devices used as attachments/couplings to the tap/faucet/spigot and enable utilization of the tap/faucet/spigot for various purposes.

Presently, the fluid supply accessories are not compatible with each other due to differences and inconsistencies in sizes and designs of each of the taps/faucets/spigots and the fluid supply accessories. Thus, coupling or attachment of the taps/faucets/spigots and the fluid supply accessories results in leakage of fluids from the taps/faucets/spigots. Moreover, coupling connections between the taps/faucets/spigots and the fluid supply accessories are not stable. More specifically, connection of the hose to the spout of the tap/faucet/spigot is not stable. Thus, there is a need for a device or an adapter that provides a stable connection/coupling of the hose to the spout and prevents leakage.

There are few patents/patent applications/non patent literatures which provide a method and a system for coupling the hose to the spout. For example, in U.S. Pat. No. 1,028,187 A, a means for attaching the hose to the faucet or for coupling two pieces of the hose together, is provided. The stated means permits rapid coupling and uncoupling of the hose and the faucet or the two pieces of the hose. However, the stated art does not teach regarding stable connection of the hose and the spout of the faucet. In addition, the stated art does not teach regarding prevention of leakage of fluids from the faucet. Moreover, the stated art does not teach regarding locking and unlocking of the faucet at different points for controlling outflow of fluids.

In another U.S. Pat. No. 6,325,425 B 1, a connector for flexible fluid lines is provided. The connector (such as garden water hoses) includes a universal body member which is common to all interconnecting components of the system. The connector includes a twist-together, twist-apart bayonet connection between component parts. Moreover, a locking lug of a first component engages a groove in an inner coupling member of a second component and a locking lug of the second component engages a groove in an inner coupling member of the first component. The stated art focuses on the flexible fluid lines. In addition, the stated art uses lock lugs as a connector-means at an opening which engages grooves in the inner coupling member and tries to form a lock system. However, the lock system, formed with the grooves, fails due to force of fluids in the flexible fluid lines. Moreover, the stated art does not teach regarding leakage control and stability. Further, the stated art does not teach regarding stable connection of the hose to the spout of the flexible fluid line. Furthermore, the stated art does not teach regarding stable and efficient locking and unlocking of valve connection of the tap/faucet/spigot at different points to enable controlled flow of liquid.

In yet another Patent WO 2014000063 A1, a tap hose universal pneumatic adapter is provided. The adapter is configured to be attached to any domestic bath tap to direct the flow of water to a sanitation hose or shower. Moreover, the adapter is in form of an arcuate conical sleeve with a neck connected to hoses by means of a standard sleeve and has a ring inside. Further, the adapter includes an elastomeric sealing tube in form of an arcuate double cone, protected by a tubular cover of fine, strong fabric in order to restrict expansion. When penetrated by a tap or pipe and with the sealing tube thereof inflated, using a manual or electric/electronic air-pump system, the adapter seals around the tap or pipe where it is anchored by fastening in order to prevent any shift thereof, thereby securing the controlled flow of water to the hose or sanitation shower and with residual discharge of water, or another liquid, directed to the wash basin via a small pipe. However, the stated art does not teach regarding stable connection of the hose to the spout to prevent leakage of fluids.

In light of the above stated discussion, there is a need for a method and system that overcomes the above stated disadvantages and provides an efficient adapter for coupling the hose to the spout. Moreover, the method and system should provide the adapter that enables coupling of different sizes of the hoses and the spouts. Further, the method and system should provide the adapter that can be coupled and decoupled when needed. Furthermore, the method and system should provide the adapter that enables stable and leak-proof connection of the hose and the spout.

### SUMMARY

In an aspect of the present disclosure, a plumbing assembly is provided. The plumbing assembly includes a plumbing adapter. The plumbing adapter includes a first portion having a hose pipe, a second portion having a support assembly and a third portion having a lock assembly. The hose pipe connects to a tap spout of a water dispensing system. The support assembly includes two parallel arms to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system.

In an embodiment of the present disclosure, the plumbing assembly includes a gasket to provide a leak-proof stable connection of the plumbing assembly to the tap spout when the hose pipe is connected to the tap spout of the water dispensing system in the lock position.

In an embodiment of the present disclosure, the lock assembly includes a clasp mechanism configured to connect a first end of the arm component to a first arm of the two parallel arms through a hook of the first arm. The clasp mechanism includes a C shaped steel clasp and the clasp mechanism enable the pivoting assembly to rotate around the first portion of the tap spout to enable the plumbing assembly to make the transition between the lock position and the unlock position.

In an embodiment of the present disclosure, the lock assembly includes a hinge assembly to connect a second end of the arm component to a second arm of the two parallel arms. The hinge assembly enable the pivoting assembly to rotate around the first portion of the tap spout to enable the plumbing assembly to make the transition between the lock position and the unlock position.

In an embodiment of the present disclosure, the lever component rotates towards left at an angle of 90 degrees, enables moving of the vertical threaded post down onto a spout diverter valve and creates a pressure to seat a gasket in the first portion.

In an embodiment of the present disclosure, the rotation of the pivoting assembly to make the transition between the lock position and the unlock position prevents an obstruction of the spout diverter valve.

In an embodiment of the present disclosure, the plumbing assembly includes a fulcrum to adjust the plumbing assembly to the liquid dispensing system.

In an embodiment of the present disclosure, the fulcrum fixes the pivoting assembly at a locking point of the liquid dispensing system.

In an embodiment of the present disclosure, the hose pipe is a male hose connector and the male hose connector connects to the tap spout of the water dispensing system.

In another embodiment of the present disclosure, the hose pipe is a female hose connector and the female hose connector connects to the tap spout of the water dispensing system.

In another aspect of the present disclosure, a plumbing assembly is provided. The plumbing assembly includes a plumbing adapter. The plumbing adapter includes a first portion having a hose pipe, a second portion having a support assembly, a third portion having a lock assembly and a gasket. The hose pipe is configured to connect to a tap spout of a water dispensing system. The support assembly includes two parallel arms configured to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system. The gasket provides a leak-proof stable connection of the plumbing assembly to the tap spout when the hose pipe is connected to the tap spout of the water dispensing system in the lock position.

In an embodiment of the present disclosure, the lock assembly includes a clasp mechanism to connect a first end of the arm component to a first arm of the two parallel arms through a hook of the first arm. The clasp mechanism includes a C shaped steel clasp and the clasp mechanism enable the pivoting assembly to rotate around the first portion of the tap spout to enable the plumbing assembly to make the transition between the lock position and the unlock position.

In an embodiment of the present disclosure, the lock assembly further includes a hinge assembly to connect a second end of the arm component to a second arm of the two parallel arms. The hinge assembly enable the pivoting assembly to rotate around the first portion of the tap spout to enable the plumbing assembly to make the transition between the lock position and the unlock position.

In an embodiment of the present disclosure, the lever component rotates towards left at an angle of 90 degrees, enables moving of the vertical threaded post down onto a spout diverter valve and creates a pressure to seat the gasket in the first portion.

In an embodiment of the present disclosure, the rotation of the pivoting assembly to make the transition between the lock position and the unlock position prevents an obstruction of the spout diverter valve.

In an embodiment of the present disclosure, the plumbing assembly includes a fulcrum to adjust the plumbing assembly to the liquid dispensing system. The fulcrum fixes the pivoting assembly at a locking point of the liquid dispensing system.

In an embodiment of the present disclosure, the hose pipe is a male hose connector. The male hose connector connects to the tap spout of the water dispensing system.

In another embodiment of the present disclosure, the hose pipe is a female hose connector. The female hose connector connects to the tap spout of the water dispensing system.

In yet another aspect of the present disclosure, a plumbing assembly is provided. The plumbing assembly includes a plumbing adapter. The plumbing adapter includes a first portion having a hose pipe, a second portion having a support assembly and a third portion having a lock assembly. The hose pipe is configured to connect to a tap spout of a water dispensing system. The support assembly includes two parallel arms configured to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system. The rotation of the pivoting assembly to make a transition between the lock position and the unlock position prevents an obstruction of a spout diverter valve.

In an embodiment of the present disclosure, the plumbing assembly includes a fulcrum configured to adjust the plumbing assembly to the liquid dispensing system. The fulcrum fixes the pivoting assembly at a locking point of the liquid dispensing system.

### BRIEF DESCRIPTION OF THE FIGURES

Having thus described the invention in general terms, reference will now be made to the accompanying drawings, which are not necessarily drawn to scale, and wherein:

FIG. 1A illustrates various components of a male tub adapter, in accordance with an embodiment of the present disclosure;

FIG. 1B illustrates various components of a female tub adapter, in accordance with an embodiment of the present disclosure;

FIG. 2A illustrates a male tub adapter, in accordance with another embodiment of the present disclosure; and

FIG. 2B illustrates a female tub adapter, in accordance with another embodiment of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

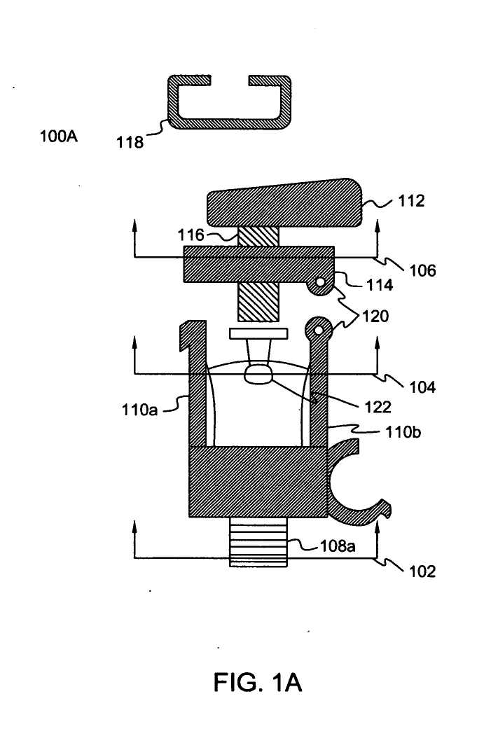

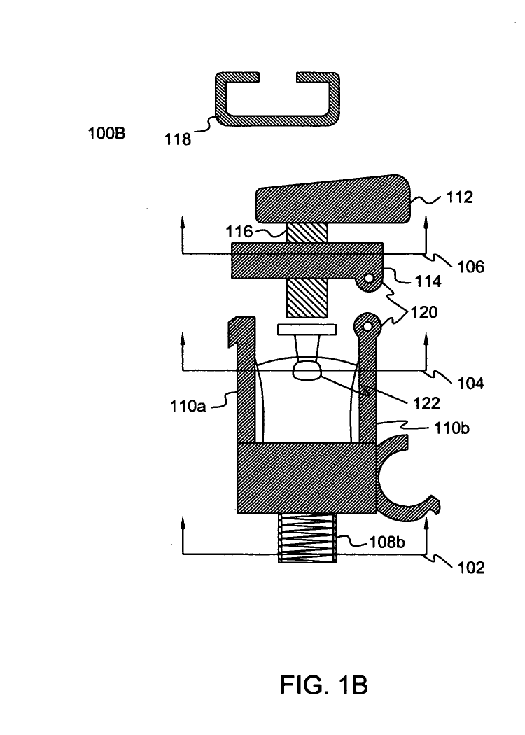

FIG. 1A illustrates various components of a male tub adapter 100a, in accordance with an embodiment of the present disclosure. The male tub adapter 100a is a plumbing adapter of a plumbing assembly. The plumbing adapter includes a first portion 102, a second portion 104 and a third portion 106. The first portion 102 includes a hose pipe; the second portion 104 includes a support assembly; and the third portion 106 includes a lock assembly. The hose pipe in the first portion 102 of the male tub adapter 100a is a male hose connector 108a. The male hose connector 108a is externally threaded and connects to a tap spout of a liquid dispensing system.

The support assembly in the second portion 104 of the male tub adapter 100a includes two parallel arms to support the hose pipe (the male hose connector 108a) at a first side. The two parallel arms include a first arm 110a and a second arm 110b. In an embodiment of the present disclosure, the two parallel arms rest on a supporting base. The lock assembly in the third portion 106 of the male tub adapter 100a includes a pivoting assembly. The pivoting assembly rotates to enable the plumbing assembly to make a transition between a lock position and an unlock position when the hose pipe is connected to the tap spout of the water dispensing system. The pivoting assembly includes a lever component 112, an arm component 114 and a vertical threaded post 116. The vertical threaded post 116 connects the lever component 112 and the arm component 114 at a second side.

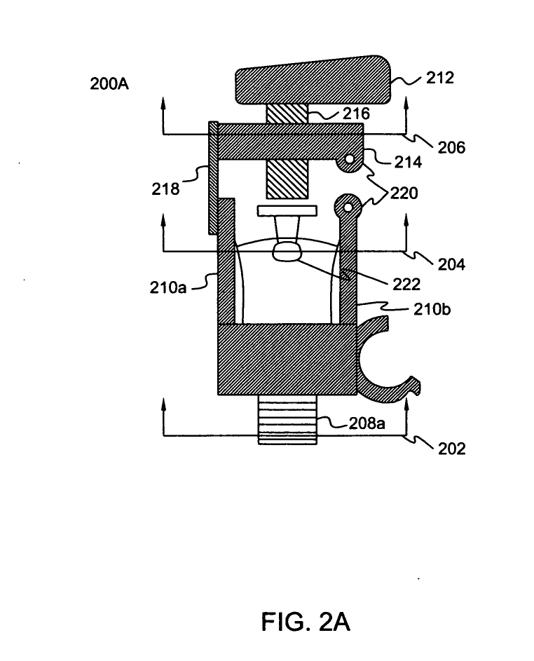

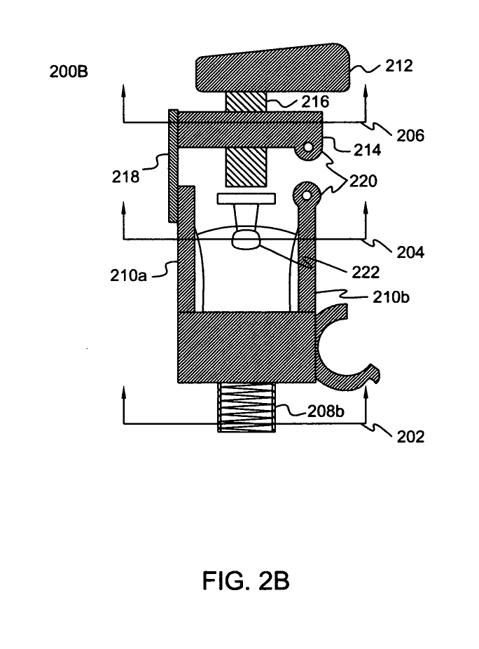

Further, the lock assembly in the third portion 106 includes a clasp mechanism 118. The clasp mechanism 118 includes a C-shaped clasp that connects a first end of the arm component 114 to the first arm 110a of the two parallel arms through a hook of the first arm 110a. The C-shaped clasp is made of steel. In an embodiment of the present disclosure, one end of the first arm 110a is shaped as the hook to receive the C-shaped clasp of the clasp mechanism 118 from above. Moreover, the clasp mechanism 118 enables the pivoting assembly to rotate around the first portion 102 of the tap spout. The pivoting assembly rotates around the first portion 102 of the male tub adapter 100a to enable the plumbing assembly to make the transition between the lock position and the unlock position (discussed later in detailed description of FIG. 2A and FIG. 2B) when the hose pipe (the male hose connector 108a) is connected to the tap spout of the liquid dispensing system.

In addition, the lock assembly includes a hinge assembly 120. The hinge assembly 120 connects a second end of the arm component 114 to a second arm 110b of the two parallel arms by using one or more hinge pins. In an embodiment of the present disclosure, the one or more hinge pins goes into the second arm 110b and the right side of the arm component 114 swings open at the second arm 110b. The one or more hinge pins are made of the steel. Moreover, the hinge assembly 120 enables the pivoting assembly to rotate around the first portion 102 of the tap spout. The pivoting assembly rotates around the first portion 102 of the male tub adapter 100a to enable the plumbing assembly to make a transition between the lock position and the unlock position when the hose pipe (the male hose connector 108a) is connected to the tap spout of the liquid dispensing system.

FIG. 1B illustrates various components of a female tub adapter 100b, in accordance with an embodiment of the present disclosure. The female tub adapter 100b is the plumbing adapter of the plumbing assembly. As described in description of FIG. 1A, the plumbing adapter includes the first portion 102, the second portion 104 and the third portion 106. The first portion 102 includes the hose pipe; the second portion 104 includes the support assembly; and the third portion 106 includes the lock assembly. The hose pipe in the first portion 102 of the female tub adapter 100b is a female hose connector 108b. The female hose connector 108b is internally threaded and connects to the tap spout of a liquid dispensing system.

The support assembly in the second portion 104 of the female tub adapter 100b includes two parallel arms to support the hose pipe (the female hose connector 108b) at the first side. The two parallel arms include the first arm 110a and the second arm 110b. In an embodiment of the present disclosure, the two parallel arms rest on the supporting base. The lock assembly in the third portion 106 of the female tub adapter 100b includes the pivoting assembly. The pivoting assembly rotates to enable the plumbing assembly to make the transition between the lock position and the unlock position when the hose pipe is connected to the tap spout of the water dispensing system. The pivoting assembly includes the lever component 112, the arm component 114 and the vertical threaded post 116. The vertical threaded post 116 connects the lever component 112 and the arm component 114 at the second side.

Further, the lock assembly in the third portion 106 includes the clasp mechanism 118. The clasp mechanism 118 includes the C-shaped clasp that connects the first end of the arm component 114 to the first arm 110a of the two parallel arms through the hook of the first arm 110a. The C-shaped clasp is made of the steel. In an embodiment of the present disclosure, the one end of the first arm 110a is shaped as the hook to receive the C-shaped clasp of the clasp mechanism 118 from above. Moreover, the clasp mechanism 118 enables the pivoting assembly to rotate around the first portion 102 of the tap spout. The pivoting assembly rotates around the first portion 102 of the female tub adapter 100b to enable the plumbing assembly to make the transition between the lock position and the unlock position (discussed later in detailed description of FIG. 2A and FIG. 2B) when the hose pipe (the female hose connector 108b) is connected to the tap spout of the liquid dispensing system.

In addition, the lock assembly includes the hinge assembly 120. The hinge assembly 120 connects the second end of the arm component 114 to the second arm 110b of the two parallel arms by using the one or more hinge pins. In an embodiment of the present disclosure, the one or more hinge pins goes into the second arm 110b and the right side of the arm component 114 swings open at the second arm 110b. The one or more hinge pins are made of the steel. Moreover, the hinge assembly 120 enables the pivoting assembly to rotate around the first portion 102 of the tap spout. The pivoting assembly rotates around the first portion 102 of the female tub adapter 100b to enable the plumbing assembly to make the transition between the lock position and the unlock position when the hose pipe (the female hose connector 108b) is connected to the tap spout of the liquid dispensing system.

FIG. 2A illustrates a male tub adapter 200a, in accordance with another embodiment of the present disclosure. The male tub adapter 200a is a plumbing adapter of a plumbing assembly. The plumbing adapter includes a first portion 202, a second portion 204 and a third portion 206. The first portion 202 includes a hose pipe; the second portion 204 includes a support assembly; and the third portion 206 includes a lock assembly. The hose pipe in the first portion 202 of the male tub adapter 200a is a male hose connector 208a. The male hose connector 208a is externally threaded and connects to a tap spout of a liquid dispensing system. The male hose connector 208a of the male tub adapter 200a is fitted at a contoured region underneath a circumference of the tap spout with a channel for liquid flow.

The support assembly in the second portion 204 of the male tub adapter 200a includes two parallel arms to support the hose pipe (the male hose connector 208a) at a first side. The two parallel arms include a first arm 210a and a second arm 210b. In an embodiment of the present disclosure, the two parallel arms rest on a supporting base. The lock assembly in the third portion 206 of the male tub adapter 200a includes a pivoting assembly. The pivoting assembly rotates to enable the plumbing assembly to make a transition between a lock position and an unlock position when the hose pipe is connected to the tap spout of the water dispensing system. The pivoting assembly includes a lever component 212, an arm component 214 and a vertical threaded post 216. The vertical threaded post 216 connects the lever component 212 and the arm component 214 at a second side.

Further, the lock assembly in the third portion 206 includes a clasp mechanism 218. The clasp mechanism 218 includes a C-shaped clasp that connects a first end of the arm component 214 to the first arm 210a of the two parallel arms through a hook of the first arm 210a. The C-shaped clasp is made of the steel. In an embodiment of the present disclosure, one side of the C-shaped clasp is vertically attached to the arm component 214 and other side of the C-shaped clasp is vertically attached to the first arm 210a. In an embodiment of the present disclosure, one end of the first arm 210a is shaped as the hook to receive the C-shaped clasp of the clasp mechanism 218 from above. Moreover, the clasp mechanism 218 enables the pivoting assembly to rotate around the first portion 202 of the tap spout. The pivoting assembly rotates around the first portion 102 of the male tub adapter 200a to enable the plumbing assembly to make a transition between the lock position and the unlock position (described later) when the hose pipe (the male hose connector 208a) is connected to the tap spout of the liquid dispensing system.

In addition, the lock assembly includes a hinge assembly 220. The hinge assembly 220 connects a second end of the arm component 214 to the second arm 210b of the two parallel arms by using one or more hinge pins. In an embodiment of the present disclosure, the one or more hinge pins goes into the second arm 210b and the right side of the arm component 214 swings open at the second arm 210b. The one or more hinge pins are made of the steel. Moreover, the hinge assembly 220 enables the pivoting assembly to rotate around the first portion 202 of the tap spout. The pivoting assembly rotates around the first portion 202 of the male tub adapter 200a to enable the plumbing assembly to make the transition between the lock position and the unlock position when the hose pipe (the male hose connector 208a) is connected to the tap spout of the liquid dispensing system.

In an embodiment of the present disclosure, the pivoting assembly opens on the one or more hinge pins and attaches to other side with the C-shaped clasp and the hook.

In the locked position, the lever component 212 of the pivoting assembly cranks or rolls from a one end to left at an angle of 90 degrees and turns the vertical threaded post 216 down onto a spout diverter valve 222 below creating a pressure to seat a gasket in the first portion 202. Further, the turning squeezes the first portion 202 and the second portion 204 up and seals the gasket inside the first portion 202. In an unlocked position, the lever component 212 of the pivoting assembly rolls away from the spout diverter valve 222 of the liquid dispensing system and gets aligned towards right direction of the plumbing assembly.

The spout diverter valve 222 is present in the second portion 204 of the male tub adapter 200a. The rotation of the pivoting assembly to make the transition between the lock position and the unlock position prevents an obstruction of the spout diverter valve 222. Further, a well that encloses/surround the tap spout with the gasket is larger in size. The gasket provides a leak-proof stable connection of the plumbing assembly to the tap spout when the hose pipe is connected to the tap spout of the water dispensing system in the lock position. The male tub adapter 200a, the gasket and the liquid dispensing system are coupled to each other to provide a stable connection between the tap spout of the liquid dispensing system and the hose pipe (the male hose connector 208a) of the male tub adapter 200a.

Furthermore, the male tub adapter 200a includes a fulcrum to adjust the plumbing assembly to the liquid dispensing system. In addition, the fulcrum fixes the pivoting assembly at a locking point of the liquid dispensing system.

FIG. 2B illustrates a female tub adapter 200b, in accordance with another embodiment of the present disclosure. The female tub adapter 200b is the plumbing adapter of the plumbing assembly. As illustrated in detailed description of FIG. 2A, the plumbing adapter includes the first portion 202, the second portion 204 and the third portion 206. The first portion 202 includes the hose pipe; the second portion 204 includes the support assembly; and the third portion 206 includes the lock assembly. The hose pipe in the first portion 202 of the female tub adapter 200b is a female hose connector 208b. The female hose connector 208b is internally threaded and connects to the tap spout of the liquid dispensing system. The female hose connector 208b of the female tub adapter 200b is fitted at the contoured region underneath a circumference of the tap spout with the channel for the liquid flow.

The support assembly in the second portion 204 of the female tub adapter 200b includes the two parallel arms to support the hose pipe (the female hose connector 208b) at the first side. The two parallel arms include the first arm 210a and the second arm 210b. In an embodiment of the present disclosure, the two parallel arms rest on the supporting base. The lock assembly in the third portion 206 of the female tub adapter 200b includes the pivoting assembly. The pivoting assembly rotates to enable the plumbing assembly to make the transition between the lock position and the unlock position when the hose pipe is connected to the tap spout of the water dispensing system. The pivoting assembly includes the lever component 212, the arm component 214 and the vertical threaded post 216. The vertical threaded post 216 connects the lever component 212 and the arm component 214 at the second side.

Further, the lock assembly in the third portion 206 includes the clasp mechanism 218. The clasp mechanism 218 includes the C-shaped clasp that connects the first end of the arm component 214 to the first arm 210a of the two parallel arms through the hook of the first arm 210a. The C-shaped clasp is made of the steel. In an embodiment of the present disclosure, the one side of the C-shaped clasp is vertically attached to the arm component 214 and the other side of the C-shaped clasp is vertically attached to the first arm 210a. In an embodiment of the present disclosure, the one end of the first arm 210a is shaped as the hook to receive the C-shaped clasp of the clasp mechanism 218 from above. Moreover, the clasp mechanism 218 enables the pivoting assembly to rotate around the first portion 202 of the tap spout. The pivoting assembly rotates around the first portion 202 of the female tub adapter 200b to enable the plumbing assembly to make a transition between the lock position and the unlock position (described later) when the hose pipe (the female hose connector 208b) is connected to the tap spout of the liquid dispensing system.

In addition, the lock assembly includes a hinge assembly 220. The hinge assembly 220 connects the second end of the arm component 214 to the second arm 210b of the two parallel arms by using the one or more hinge pins. In an embodiment of the present disclosure, the one or more hinge pins goes into the second arm 210b and the right side of the arm component 214 swings open at the second arm 210b. The one or more hinge pins are made of the steel. Moreover, the hinge assembly 220 enables the pivoting assembly to rotate around the first portion 202 of the tap spout. The pivoting assembly rotates around the first portion 202 of the female tub adapter 200b to enable the plumbing assembly to make the transition between the lock position and the unlock position when the hose pipe (the male hose connector 208a) is connected to the tap spout of the liquid dispensing system.

In the locked position, the lever component 212 of the pivoting assembly cranks or rolls from a one end to left at an angle of 90 degrees and turns the vertical threaded post 216 down onto the spout diverter valve 222 below creating a pressure to seat a gasket in the first portion. Further, the turning squeezes the first portion 202 and the second portion 204 up and seals the gasket inside the first portion. In an unlocked position, the lever component 212 of the pivoting assembly rolls away from the spout diverter valve 222 of the liquid dispensing system and gets aligned towards the right direction of the plumbing assembly.

The spout diverter valve 222 is present in the second portion 104 of the female tub adapter 200b. The rotation of the pivoting assembly to make the transition between the lock position and the unlock position prevents the obstruction of the spout diverter valve 222. Further, the well that encloses/surround the tap spout with the gasket is larger in size. The gasket provides the leak-proof stable connection of the plumbing assembly to the tap spout when the hose pipe is connected to the tap spout of the water dispensing system in the lock position. The female tub adapter 200b, the gasket and the liquid dispensing system are coupled to each other to provide the stable connection between the tap spout of the liquid dispensing system and the hose pipe (the female hose connector 208b) of the female tub adapter 200b.

Furthermore, the female tub adapter 200b includes the fulcrum to adjust the plumbing assembly to the liquid dispensing system. In addition, the fulcrum fixes the pivoting assembly at the locking point of the liquid dispensing system.

In an embodiment of the present disclosure, the hose pipe of the plumbing adapter is at least one of the male hose connector 108a, the male hose connector 208a, the female hose connector 108b and the female hose connector 208b.

The plumbing adapter of the plumbing assembly has several advantages. The plumbing adapter enables coupling of variable size hose pipes to the tap spouts of the liquid dispensing system. Further, the plumbing adapter is made using high strength plastic material, thus increasing an efficiency of the plumbing adapter. In addition, the plumbing adapter can be coupled and decoupled to the liquid dispensing system when needed. Further, the plumbing adapter enables the stable and the leak-proof connection of the hose and the spout (as described above).

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A plumbing assembly comprising:
a plumbing adapter, wherein the plumbing adapter comprising:
a first portion having a hose pipe, wherein the hose pipe is configured to connect to a tap spout of a water dispensing system;
a second portion having a support assembly, wherein the support assembly comprising:
two parallel arms configured to support the hose pipe at a first side; and
a third portion having a lock assembly, wherein the lock assembly comprising:
a pivoting assembly, the pivoting assembly comprises a lever component, an arm component and a vertical threaded post connecting the lever component and the arm component at a second side, and wherein the pivoting assembly rotates to enable the plumbing assembly to make a transition between a lock position and an unlock position when the hose pipe is connected to the tap spout of the water dispensing system.

2. The plumbing assembly of claim 1, further comprising a gasket configured to provide a leak-proof stable connection of the plumbing assembly to the tap spout when the hose pipe is connected to the tap spout of the water dispensing system in the lock position.

3. The plumbing assembly as recited in claim 1, wherein the lock assembly further comprises a clasp mechanism configured to connect a first end of the arm component to a first arm of the two parallel arms through a hook of the first arm, wherein the clasp mechanism comprises a C shaped steel clasp, and wherein the clasp mechanism enable the pivoting assembly to rotate around the first portion of the tap spout to enable the plumbing assembly to make the transition between the lock position and the unlock position.

4. The plumbing assembly as recited in claim 1, wherein the lock assembly further comprises a hinge assembly configured to connect a second end of the arm component to a second arm of the two parallel arms, and wherein the hinge assembly enable the pivoting assembly to rotate around the first portion of the tap spout to enable the plumbing assembly to make the transition between the lock position and the unlock position.

5. The plumbing assembly as recited in claim 1, wherein the lever component rotates towards left at an angle of 90 degrees, enables moving of the vertical threaded post down onto a spout diverter valve and creates a pressure to seat a gasket in the first portion.

6. The plumbing assembly as recited in claim 1, wherein the rotation of the pivoting assembly to make the transition between the lock position and the unlock position prevents an obstruction of the spout diverter valve.

7. The plumbing assembly as recited in claim 1, wherein the plumbing assembly further comprises a fulcrum configured to adjust the plumbing assembly to the liquid dispensing system.

8. The plumbing assembly as recited in claim 7, wherein the fulcrum is further configured to fix the pivoting assembly at a locking point of the liquid dispensing system.

9. The plumbing assembly of claim 1, wherein the hose pipe is a male hose connector, and wherein the male hose connector connects to the tap spout of the water dispensing system.

10. The plumbing assembly of claim 1, where wherein the hose pipe is a female hose connector, and wherein the female hose connector connects to the tap spout of the water dispensing system.

11. A plumbing assembly comprising:
a plumbing adapter, wherein the plumbing adapter comprising:
a first portion having a hose pipe, wherein the hose pipe is configured to connect to a tap spout of a water dispensing system;
a second portion having a support assembly, wherein the support assembly comprising:
two parallel arms configured to support the hose pipe at a first side;
a third portion having a lock assembly, wherein the lock assembly comprising:
a pivoting assembly, the pivoting assembly comprises a lever component, an arm component and a vertical threaded post connecting the lever component and the arm component at a second side, and wherein the pivoting assembly rotates to enable the plumbing assembly to make a transition between a lock position and an unlock position when the hose pipe is connected to the tap spout of the water dispensing system; and
a gasket, wherein the gasket is configured to provide a leak-proof stable connection of the plumbing assembly to the tap spout when the hose pipe is connected to the tap spout of the water dispensing system in the lock position.

12. The plumbing assembly as recited in claim 11, wherein the lock assembly further comprises a clasp mechanism configured to connect a first end of the arm component to a first arm of the two parallel arms through a hook of the first arm, wherein the clasp mechanism comprises a C shaped steel clasp, and wherein the clasp mechanism enable the pivoting assembly to rotate around the first portion of the tap spout to enable the plumbing assembly to make the transition between the lock position and the unlock position.

13. The plumbing assembly as recited in claim 11, wherein the lock assembly further comprises a hinge assembly configured to connect a second end of the arm component to a second arm of the two parallel arms, and wherein the hinge assembly enable the pivoting assembly to rotate around the first portion of the tap spout to enable the plumbing assembly to make the transition between the lock position and the unlock position.

14. The plumbing assembly as recited in claim 11, wherein the lever component rotates towards left at an angle of 90 degrees, enables moving of the vertical threaded post down onto a spout diverter valve and creates a pressure to seat the gasket in the first portion.

15. The plumbing assembly as recited in claim 11, wherein the rotation of the pivoting assembly to make the transition between the lock position and the unlock position prevents an obstruction of the spout diverter valve.

16. The plumbing assembly as recited in claim 11, wherein the plumbing assembly further comprises a fulcrum configured to adjust the plumbing assembly to the liquid dispensing system, and wherein the fulcrum is further configured to fix the pivoting assembly at a locking point of the liquid dispensing system.

17. The plumbing assembly of claim 11, wherein the hose pipe is a male hose connector, and wherein the male hose connector connects to the tap spout of the water dispensing system.

18. The plumbing assembly of claim 11, wherein the hose pipe is a female hose connector, and wherein the female hose connector connects to the tap spout of the water dispensing system.

19. A plumbing assembly comprising:
a plumbing adapter, wherein the plumbing adapter comprising:
a first portion having a hose pipe, wherein the hose pipe is configured to connect to a tap spout of a water dispensing system;
a second portion having a support assembly, wherein the support assembly comprising:
two parallel arms configured to support the hose pipe at a first side; and
a third portion having a lock assembly, wherein the lock assembly comprising:
a pivoting assembly, the pivoting assembly comprises a lever component, an arm component and a vertical threaded post connecting the lever component and the arm component at a second side, wherein the pivoting assembly rotates to enable the plumbing assembly to make a transition between a lock position and an unlock position when the hose pipe is connected to the tap spout of the water dispensing system, and wherein the rotation of the pivoting assembly to make a transition between the lock position and the unlock position prevents an obstruction of a spout diverter valve.

20. The plumbing assembly as recited in claim 19, wherein the plumbing assembly further comprises a fulcrum configured to adjust the plumbing assembly to the liquid dispensing system, and wherein the fulcrum is further configured to fix the pivoting assembly at a locking point of the liquid dispensing system.
